(19) United States
(12) Patent Application Publication
(10) Pub. No.: US 2015/0369273 A1
(43) Pub. Date: Dec. 24, 2015

(54) PART-FASTENING STRUCTURE

(71) Applicant: KABUSHIKI KAISHA HONDA LOCK, Miyazaki-shi (JP)

(72) Inventor: Tadashi SAITOU, MIYAZAKI-SHI (JP)

(21) Appl. No.: 14/740,388

(22) Filed: Jun. 16, 2015

(30) Foreign Application Priority Data
Jun. 23, 2014 (JP) 2014-127964

(51) Int. Cl. F16B 37/04

(52) U.S. Cl. CPC F16B 37/044

(57) ABSTRACT

A part-fastening structure having a nut unrotatably inserted into a nut housing portion provided to a resin-made part from a side. The part is fastened to a base by screwing a bolt inserted through the base, into the nut. The nut integrally includes a nut main portion having a screw hole in its center portion and unrotatably inserted into the housing portion, and an extending arm portion extending laterally from an outer periphery of the main portion. A through-hole for penetration of the arm portion is provided to a sidewall opposite an insertion opening, through which the main portion is inserted. A rotation preventing portion is integrally provided to the part and prevents rotation of the nut by abutting against at least a tip end portion of the arm portion. Accordingly, load the part receives due to fastening rotational torque of the bolt is minimized.

### CROSS REFERENCE TO RELATED APPLICATIONS

The present application claims priority under 35 U.S.C. §119 to Japanese Patent Application No. 2014-127964 filed Jun. 23, 2014 the entire contents of which are hereby incorporated by reference.

### BACKGROUND OF THE INVENTION

1. Field of the Invention

The present invention relates to a part-fastening structure in which a nut is unrotatably inserted into a nut housing portion which is provided to a resin-made part from a side of the nut housing portion, and the part is fastened to a base by screwing a bolt, which is inserted through the base, to the nut.

2. Description of the Related Art

Some vehicles use a fastening structure in which a resin-made door handle case as a part is fastened to a door panel as a base by screwing a bolt, which is inserted through the door panel, to a nut unrotatably inserted into the door handle case. Such a fastening structure is common and disclosed in Japanese Patent Application Laid-open No. 2000-337338, for example.

In the fastening structure disclosed in Japanese Patent Application Laid-open No. 2000-337338, however, the nut is formed having a non-circular external shape such as a hexagonal shape or a quadrangular shape, and fastening rotational torque for fastening the bolt which is screwed to the nut is received by abutment portions of the nut which abut against sidewalls of a nut housing portion. The fastening rotational torque acts on the sidewalls of the nut housing portion at a position relatively close to a center of a screw hole of the nut. For these reasons, if the fastening rotational torque for fastening the bolt is large, excessive load acts on the sidewalls of the nut housing portion. Accordingly, there is likelihood that: the nut housing portion is deformed so as to cause idle rotation of the nut. As a measure to counter this likelihood, a thickness of the sidewalls of the nut housing portion needs to be increased, and/or the part needs to be formed from high-strength material. This measure leads to an increase in size and weight, as well as restriction on shape.

### SUMMARY OF THE INVENTION

The present invention has been made with the foregoing situation taken into consideration. An object of the present invention is to provide a part-fastening structure that is capable of minimizing load which the part receives due to the fastening rotational torque for fastening the bolt.

In order to achieve the object, according to a first aspect of the present invention, there is provided a part-fastening structure in which a nut is unrotatably inserted into a nut housing portion which is provided to a resin-made part from a side of the nut housing portion, and the part is fastened to a base by screwing a bolt, which is inserted through the base, to the nut, wherein the nut is formed to integrally include: a nut main portion having a screw hole in a center portion thereof, and unrotatably inserted into the nut housing portion, and an extending arm portion extending laterally from an outer periphery of the nut main portion, a through-hole for penetration of the extending arm portion therethrough is provided to a sidewall opposite to an insertion opening of the nut housing portion, the insertion opening being used for insertion of the nut main portion therethrough, and the part is integrally provided with a rotation preventing portion for preventing rotation of the nut by abutting against at least a tip end portion of the extending arm portion.

According to the first aspect of the present invention, the nut integrally includes: the nut main portion having the screw hole; and the extending arm portion extending laterally from the outer periphery of the nut main portion. The rotation preventing portion abutting against at least the tip end portion of the extending arm portion can minimize load which the part inclusive of the nut housing portion receives due to rotational torque for fastening the bolt while preventing the rotation of the nut at a position away from a center of rotation of the nut, since the rotation preventing portion is integrally provided to the part so as to prevent the rotation of the nut. The sidewall of the nut housing portion no longer needs to be made thicker than necessary. In addition, the part no longer needs to be formed especially from high-strength material. Furthermore, because the extending arm portion can keep its strength even though its width is set smaller, the through-hole provided to the sidewall of the nut housing portion no longer needs to be formed larger than necessary, and strength of the sidewall of the nut housing portion can be secured.

According to a second aspect of the present invention, in addition to the first aspect, the nut is formed symmetrically with respect to a plane passing a center in a width direction of the extending arm portion and a center of the screw hole.

According to the second aspect of the present invention, a shape of the nut is symmetrical with respect to the plane passing the center in the width direction of the extending arm portion and the center of the screw hole. For this reason, when a symmetrical pair of left and right parts are fastened to the respective bases, the nut can be used commonly for each of the left and right parts.

According to a third aspect of the present invention, in addition to the first or second aspect, the nut housing portion is provided with a pair of guide ribs which project from the part so as to guide the extending arm portion from opposite sides in a width direction of the extending arm portion when inserting the nut into the nut housing portion from the insertion opening.

According to the third aspect of the present invention, when the nut is inserted into the nut housing portion, the pair of guide ribs guide the extending arm portion of the nut from the opposite sides in the width direction of the extending arm portion. Thereby, it is possible to smoothly guide the extending arm portion to the through-hole side; it is easy to insert the nut into the nut housing portion; and it is possible to enhance assembling workability.

According to a fourth aspect of the present invention, in addition to any one of the first to third aspects, the rotation preventing portion is formed in such a shape as to abut against at least the tip end portion of the extending arm portion from a direction along a screwing direction of the bolt into the screw hole.

According to the fourth aspect of the present invention, the rotation preventing portion abuts against at least the tip end portion of the extending arm portion from the direction along the screwing direction of the bolt into the screw hole. For this reason, strength with which the part is attached to the base can be enhanced in a way that even when force in a direction in which the part comes off the base acts on the nut, the rotation preventing portion supports at least the tip end portion of the extending arm portion.

The above and other objects, characteristics and advantages of the present invention will be clear from detailed descriptions of the preferred embodiments which will be provided below while referring to the attached drawings.

### BRIEF DESCRIPTION OF THE DRAWINGS

FIG. 1 shows a first embodiment, and is a left side view of a rear portion of a passenger vehicle.

FIG. 2 is an enlarged sectional view taken along a 2-2 line in FIG. 1.

FIG. 3 is a perspective view of a door handle case to which an outer handle is attached, and which is viewed from inside.

FIG. 4 is an enlarged view of a main part shown in FIG. 3, in which a nut is being attached.

FIG. 5 is an enlarged sectional view taken along a 5-5 line in FIG. 3.

FIG. 6 shows a second embodiment, and is a perspective view showing that a nut is in a process of being attached to a door handle case.

FIG. 7 is a side view showing that the nut is in the process of being attached to the door handle case.

FIG. 8 is a sectional view of a state of attachment of the nut, taken along an 8-8 line in FIG. 7.

### DESCRIPTION OF THE PREFERRED EMBODIMENTS

Referring to the drawings, descriptions will be hereinbelow provided for embodiments of the present invention.

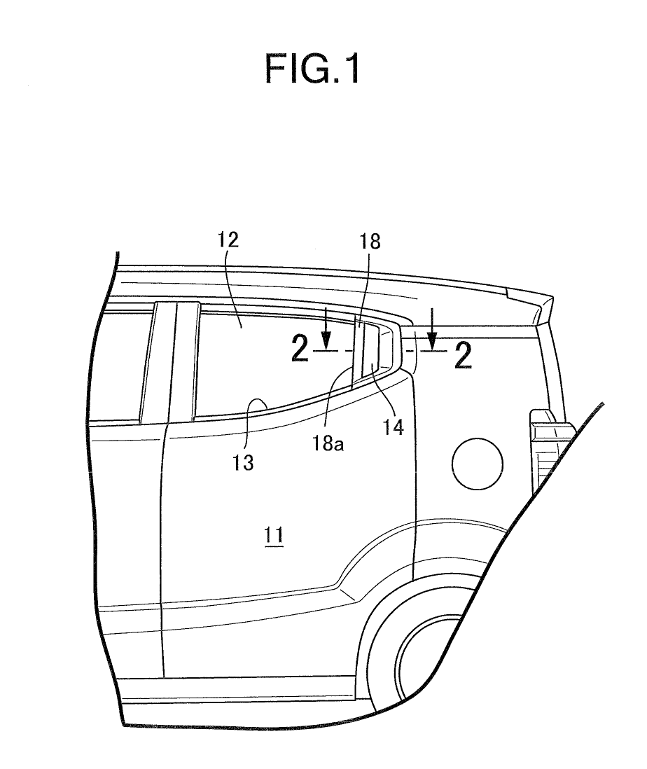

Referring to FIGS. 1 to 5, descriptions will be provided for a first embodiment of the present invention. First of all, in FIG. 1, an upper portion of a rear side door 11 provided to each of left and right sides of a rear portion of a passenger vehicle is provided with a window 13 which is opened and closed with a window glass 12 capable of being lifted and lowered, and also provided with an outer handle 14 for performing operation of opening and closing the rear side door 11.

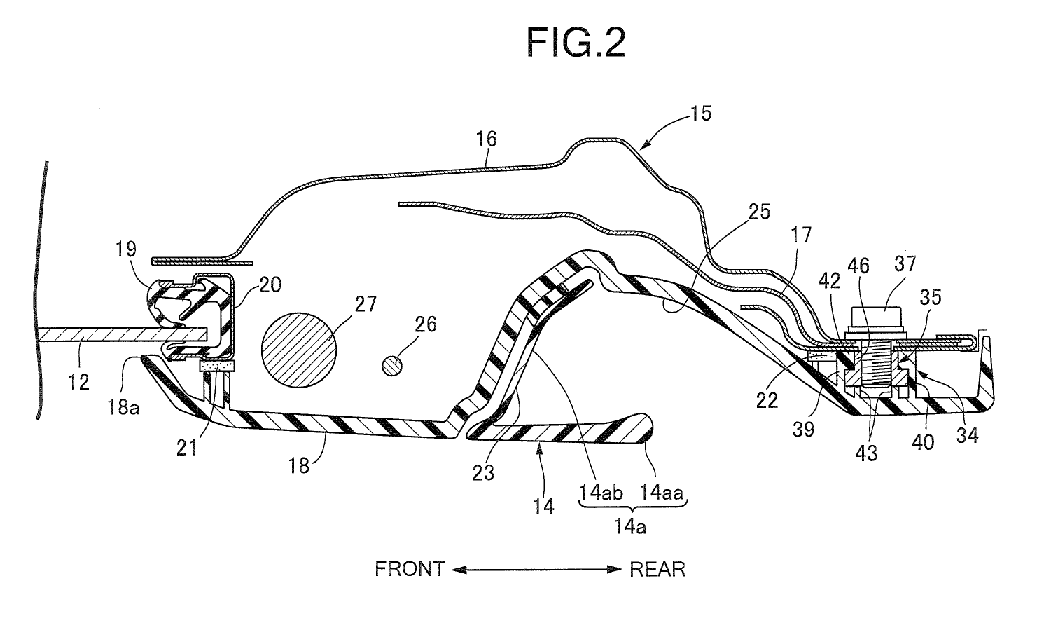

Referring to FIG. 2 together, a door panel 15 of the rear side door 11 is formed by combining multiple steel-sheet members which include an inner panel 16 and an outer panel 17 covering the inner panel 16 from outside. The outer handle 14 is rotatably supported by a door handle case 18 which is a resin-made part. The door handle case 18 is fastened to the door panel 15 as a base. The door handle case 18 is formed in a way that a front end edge 18a of the door handle case 18 forms a rear edge of the window 13. A part of a sash 20 extending up and down while holding a run channel 19 which is in slide contact with a rear edge portion of the window glass 12 is disposed between a front portion of the door handle case 18 and the door panel 15. The sash 20 is supported by the door panel 15.

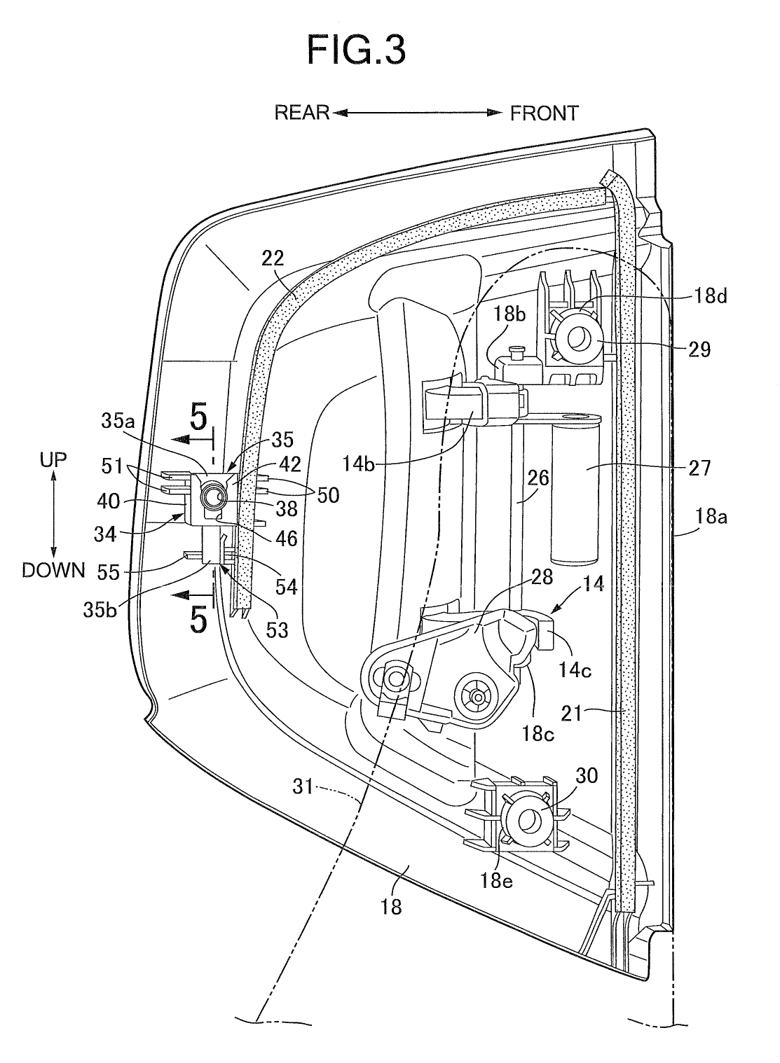

Referring to FIG. 3 together, a first seal member 21 extending up and down in the front portion of the door handle case 18 and elastically abutting against the part of the sash 20 is stuck to an inner surface of the door handle case 18. A second seal member 22 extending so as to curve from an upper portion to a rear portion of the door handle case 18 is stuck to an outer surface of the door panel 15 so as to abut against the outer surface of the door panel 15.

The outer handle 14 integrally includes: a grip portion 14a disposed on an outer side of the door handle case 18 while extending long in an up-down direction; and a pair of support arm portions 14b, 14c connectedly provided respectively to both of upper and lower end portions of the grip portion 14a. The grip portion 14a is formed from: a front wall portion 14aa enabling fingers to hook the grip portion 14a; and a rear wall portion 14ab forming a pocket portion 23, which allows insertion of the fingers into the pocket portion 23, between the front wall portion 14aa and the rear wall portion 14ab. The grip portion 14a has a cross section with a substantially V shape formed by the front wall portion 14aa and the rear wall portion 14ab.

A recessed portion 25 inwardly recessed is formed in the door handle case 18. While the outer handle 14 is not being manipulated, the grip portion 14a is housed in a front part of the recessed portion 25 while allowing insertion of a hand into the outer handle 14 from a rear of the grip portion 14a. In addition, the pair of support arm portions 14b, 14c enter an inside of the door handle case 18 by penetrating through the door handle case 18. Tip end portions of the support arm portions 14b, 14c are rotatably supported, via a spindle 26 extending up and down, by a pair of support portions 18b, 18c which are projectingly provided to the inner surface of the door handle case 18 with an interval in the up-down direction between the support portions 18b, 18c.

A weight 27 is connected to the upper support arm portion 14b which is one of the pair of upper and lower support arm portions 14b, 14c. Furthermore, a rotating member 28 is rotatably supported on the door handle case 18, the rotating member 28 being capable of transmitting force in a direction of opening a door to a latch mechanism (not illustrated) which is provided to the rear side door 11 and capable of holding the rear side door 11 closed. The lower support arm portion 14c is operatively connected to the rotating member 28. In addition, a spring (not illustrated) for biasing the rotating member 28 and the outer handle 14 in a direction of their return is provided between the rotating member 28 and the door handle case 18.

Meanwhile, the door handle case 18 is fastened to the door panel 15 at two upper and lower places in the front portion of the door handle case 18, and at one place in the rear portion of the door handle case 18. Nuts 29, 30 are buried respectively in bosses 18d, 18e projectingly provided to the inner surface of the door handle case 18 at the two upper and lower places of the front portion of the door handle case 18. Bolts (not illustrated) inserted through the door panel 15 are screwed to the nuts 29, 30. Incidentally, heads of the bolts are covered with an inner liner 31 (see FIG. 3) stuck to an inner surface of the door panel 15.

The one place in the rear portion of the door handle case 18 is fastened to the door panel 15 in accordance with the present invention. A nut 35 is unrotatably inserted into a nut housing portion 34, which is provided to the door handle case 18, from a side (an upper side in this embodiment) of the nut housing portion 34. The door handle case 18 is fastened to the door panel 15 by screwing a bolt 37, which is inserted through the door handle case 18, to the nut 35.

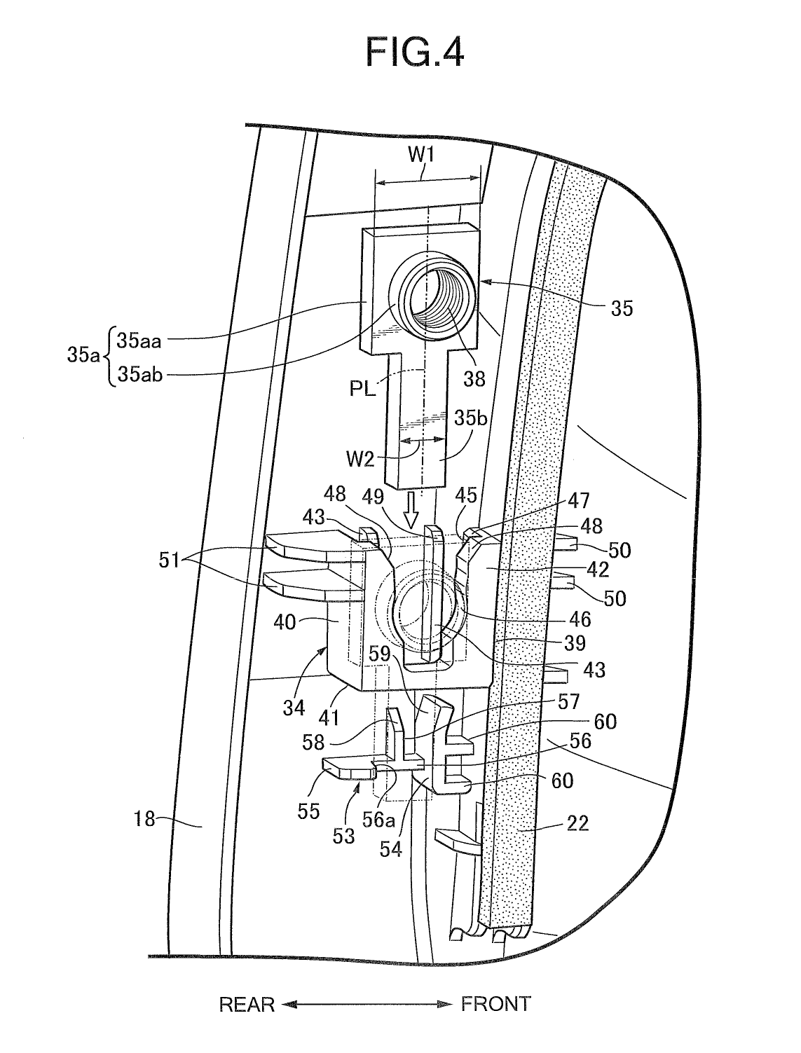

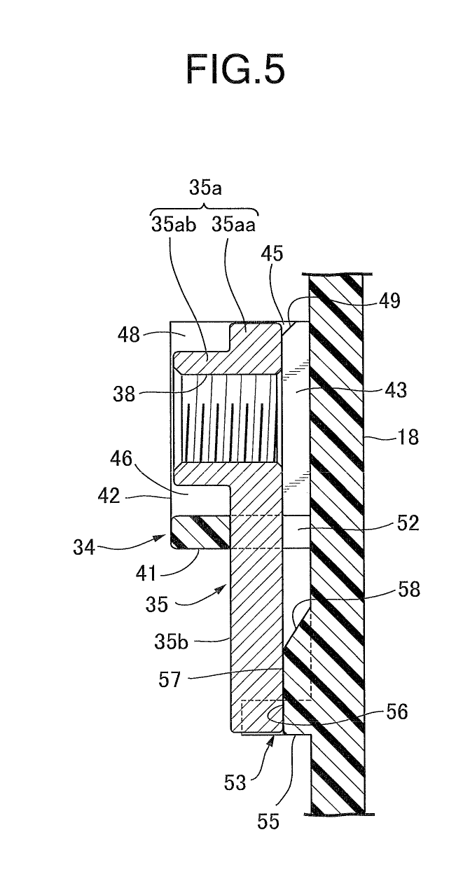

Referring to FIGS. 4 and 5, the nut 35 integrally includes: a nut main portion 35a having a screw hole 38 in a center portion thereof, and unrotatably inserted into the nut housing portion 34; and an extending arm portion 35b extending laterally from an outer periphery of the nut main portion 35a. The nut 35 is formed symmetrically with respect to a plane PL passing a center in a width direction of the extending arm portion 35b and the center of the screw hole 38.

In this embodiment, the nut main portion 35a includes: a flat plate part 35aa having a right-angle quadrilateral shape; and a cylindrical part 35ab uprightly provided to a center portion of the flat plate part 35aa. The screw hole 38 is formed coaxially with the cylindrical part 35ab. Furthermore, the extending arm portion 35b has a width W2 which is smaller than a width W1 of the flat plate part 35aa, and is integrally and connectedly provided to a center portion in a width direction of the flat plate part 35aa so as to extend in a direction orthogonal to an axis of the screw hole 38.

Meanwhile, the nut housing portion 34 includes: a front sidewall 39 and a rear sidewall 40 connectedly provided to the door handle case 18 at a right angle so as to extend up and down while sandwiching the flat plate part 35aa of the nut main portion 35a from front and rear; a lower sidewall 41 connectedly provided to the door handle case 18 at a right angle while connecting respective lower portions of the front and rear sidewalls 39, 40; a flange portion 42 sticking out inward from respective projecting end portions of the front, rear and lower sidewalls 39, 40, 41; and a pair of guide ribs 43 projectingly provided to the door handle case 18 at a right angle so as to extend up and down in parallel between the front and rear sidewalls 39, 40 with the flat plate part 35aa interposed between the pair of guide ribs 43 and the flange portion 42.

An insertion opening 45 for insertion of the nut main portion 35a therethrough is formed from respective upper end portions of the front and rear sidewalls 39, 40 and the door handle case 18 so as to open upward. The flange portion 42 forms a slit 46 continuous to the insertion opening 45. The cylindrical part 35ab of the nut housing portion 34 is disposed in the slit 46. Furthermore, a through-hole 52 for penetration of the extending arm portion 35b therethrough is provided to a sidewall opposite to the insertion opening 45 of the nut housing portion 34, namely, the lower sidewall 41, in a way that the inner surface of the door handle case 18 forms part of an inner side surface of the through-hole 52.

A distance between the pair of guide ribs 43 is set slightly larger than the width W2 of the extending arm portion 35b so that when the nut 35 is inserted into the nut housing portion 34 from the insertion opening 45, the pair of guide ribs 43 guide the extending arm portion 35b to the through-hole 52 side from the opposite sides in the width direction of the extending arm portion 35b.

Inclined guide surfaces 47 for smoothly guiding the flat plate part 35aa of the nut main portion 35a to an inside of the nut housing portion 34 are formed respectively in front and rear portions of an opening edge of the insertion opening 45. Inclined guide surfaces 48 for smoothly guiding the cylindrical part 35ab of the nut main portion 35a to an inside of the slit 46 are formed respectively in front and rear portions of an opening edge of the slit 46 which leads to the insertion opening 45. Inclined guide surfaces 49 for smoothly guiding the flat plate part 35aa of the nut main portion 35a to the inside of the nut housing portion 34 are formed respectively in upper portions of the pair of guide ribs 43.

A pair of reinforcement walls 50 with an interval in an up-down direction therebetween are provided between an outer surface of an upper portion of the front sidewall 39 and the door handle case 18, while a pair of reinforcement walls 51 with an interval in an up-down direction therebetween are provided between an outer surface of an upper portion of the rear sidewall 40 and the door handle case 18.

A rotation preventing portion 53 is integrally provided to the door handle case 18, the rotation preventing portion 53 preventing rotation of the nut 35 by abutting against at least a tip end portion of the extending arm portion 35b which projects from the through-hole 52 of the nut housing portion 34.

In this embodiment, the rotation preventing portion 53 is integrally provided to the door handle case 18 at a position spaced downward from the nut housing portion 34. The rotation preventing portion 53 includes: a longitudinal wall 54 connectedly provided to the door handle case 18 at a right angle so as to extend in an up-down direction to abut against a front edge of the tip end portion of the extending arm portion 35b; and a lateral wall 55 connectedly provided to the door handle case 18 at a right angle so as to be continuous to an intermediate portion in an up-down direction of the longitudinal wall 54 at a right angle and extend rearward from the longitudinal wall 54. A fitting recessed portion 56 including a step portion 56a facing the longitudinal wall 54 is formed in a part of the lateral wall 55 which is close to the longitudinal wall 54.

The tip end portion of the extending arm portion 35b is fitted into the fitting recessed portion 56. The rotation of the nut 35 when fastening the bolt 37 screwed to the nut 35 is prevented by the tip end portion of the extending arm portion 35b abutting against the step portion 56a. The rotation of the nut 35 in a direction opposite to that of said rotation thereof is prevented by the tip end portion of the extending arm portion 35b abutting against the longitudinal wall 54.

Below the nut housing portion 34, a guide protrusion 57 is integrally and projectingly provided to the door handle case 18 so as to extend up and down, the guide protrusion 57 being continuous to the lateral wall 55 at a right angle at a position corresponding to the fitting recessed portion 56. The guide protrusion 57 works to guide the tip end portion of the extending arm portion 35b, which projects from the nut housing portion 34, to the rotation preventing portion 53 side by abutting against a surface on the door handle case 18 side, of the tip end portion of the extending arm portion 35b. An inclined surface 58 is formed on an end portion on the nut housing portion 34 side, of the guide protrusion 57, the inclined guide surface 58 guiding the tip end portion of the extending arm portion 35b to the fitting recessed portion 56 side of the rotation preventing portion 53 when the extending arm portion 35b moves to the guide protrusion 57 from the nut housing portion 34 side while in slide contact with the inner surface of the door handle case 18.

The longitudinal wall 54 works, too, to guide the tip end portion of the extending arm portion 35b, which projects from the nut housing portion 34, to the rotation preventing portion 53 side. An inclined guide surface 59 is formed on an end portion on the nut housing portion 34 side, of the longitudinal wall 54, the inclined guide surface 59 making a front side surface of the extending arm portion 35b smoothly abut against the longitudinal wall 54 when the extending arm portion 35b moves to the longitudinal wall 54 from the nut housing portion 34 side.

In addition, a pair of reinforcement walls 60 with an interval in an up-down direction therebetween are provided between a front surface of the longitudinal wall 54 and the door handle case 18.

Next, descriptions will be provided for an operation of the first embodiment. The nut 35 is formed to integrally include: the nut main portion 35a having the screw hole 38 in the center portion thereof, and unrotatably inserted into the nut housing portion 34 of the door handle case 18; and the extending arm portion 35b extending laterally from the outer periphery of the nut main portion 35a. The through-hole 52 for penetration of the extending arm portion 35b therethrough is provided to the lower sidewall 41 opposite to the insertion opening 45 of the nut housing portion 34, the insertion opening 45 being used for insertion of the nut main portion 35a therethrough. The rotation preventing portion 53 is integrally provided to the door handle case 18, the rotation preventing portion 53 preventing the rotation of the nut 35 by abutting against at least the tip end portion of the extending arm portion 35b. For these reasons, it is possible to minimizing load which the door handle case 18 inclusive of the nut housing portion 34 receives due to rotational torque for fastening the bolt 37 while preventing the rotation of the nut 35 at the position away from the center of rotation of the nut 35. The front, rear and lower sidewalls 39, 40, 41 of the nut housing portion 34 no longer need to be made thicker than necessary. The door handle case 18 no longer needs to be formed especially from high-strength material, either. Since the extending arm portion 35b can keep its strength even though its width W2 is set smaller, the through-hole 52 provided to the lower sidewall 41 of the nut housing portion 34 no longer needs to be formed larger than necessary, and the strength of the lower sidewall 41 of the nut housing portion 34 can be secured.

Furthermore, the nut 35 is formed symmetrically with respect to the plane PL passing the center in the width direction of the extending arm portion 35b and the center of the screw hole 38. For this reason, when a symmetrical pair of left and right door handle cases 18 are fastened to the respective door panels 15, the nut 35 can be used commonly for each of the left and right door handle cases 18.

In addition, the nut housing portion 34 is provided with the pair of guide ribs 43 projecting from the door handle case 18 so that when the nut 35 is inserted into the nut housing portion 34 from the insertion opening 45, the pair of guide ribs 43 guide the extending arm portion 35b from the opposite sides in the width direction of the extending arm portion 35b. For this reason, it is possible to smoothly guide the extending arm portion 35b to the through-hole 52 side; it is easy to insert the nut 35 into the nut housing portion 34; and it is possible to enhance assembling workability.

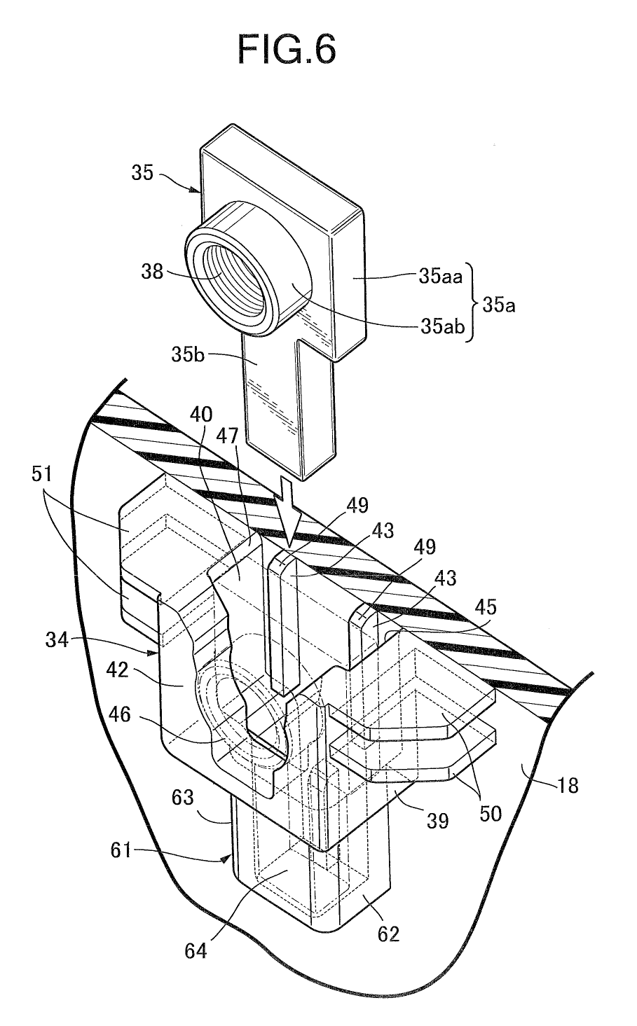

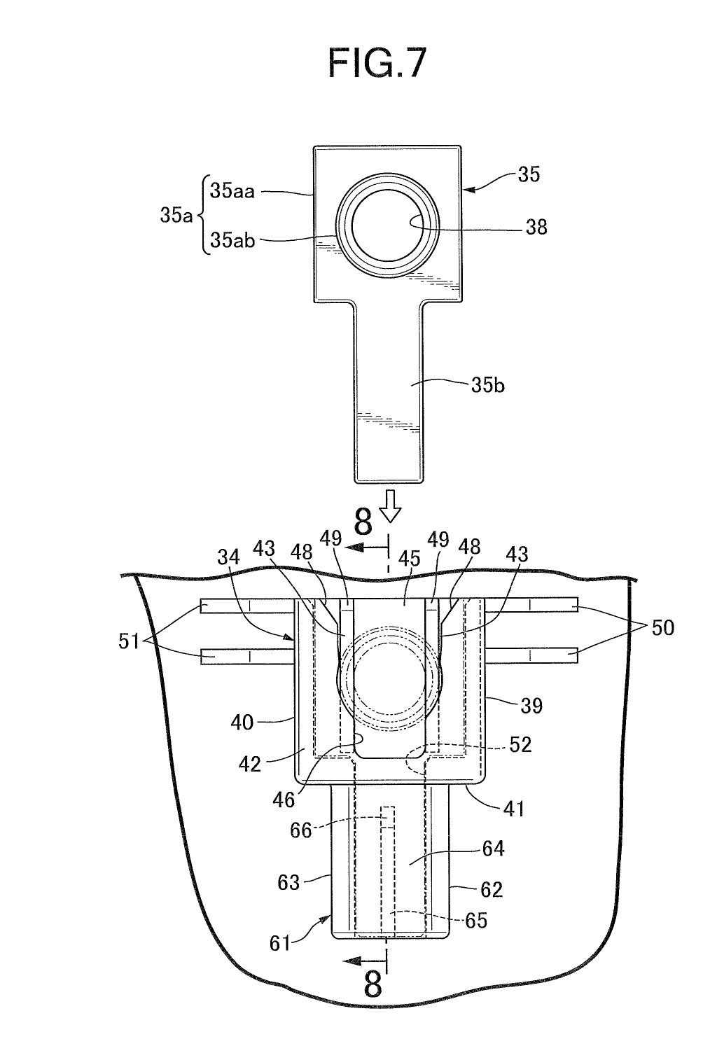

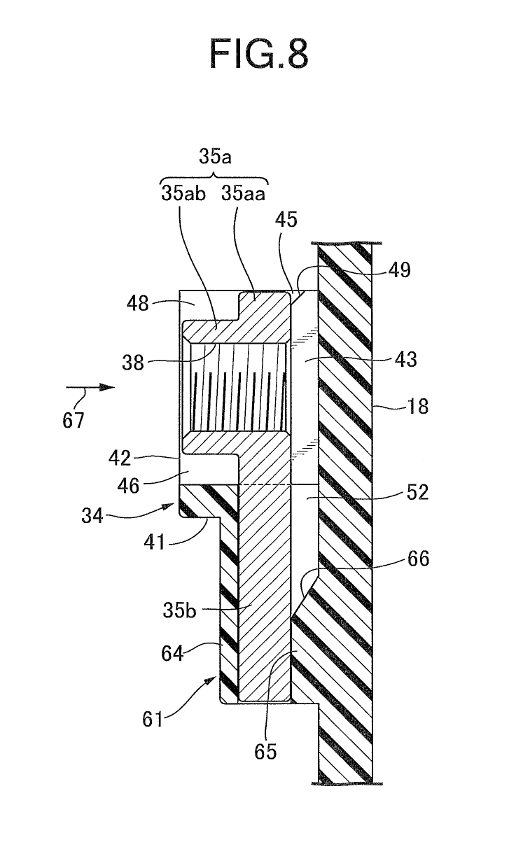

Referring to FIGS. 6 to 8, descriptions will be provided for a second embodiment of the present invention. Components corresponding to those of the first embodiment will be only illustrated by being denoted with the same reference numerals, and detailed descriptions for such components will be omitted.

Below the nut housing portion 34, a rotation preventing portion 61 is integrally provided to the door handle case 18, the rotation preventing portion 61 preventing the rotation of the nut 35 by abutting against at least the tip end portion of the extending arm portion 35b which penetrates through the through-hole 52 provided to the lower sidewall 41 of the nut housing portion 34 for housing the nut main portion 35a of the nut 35.

The rotation preventing portion 61 includes: a pair of front and rear sidewalls 62, 63 integrally and projectingly provided to the door handle case 18 so as to extend in an up-down direction over a full longitudinal length of the extending arm portion 35b projecting from the nut housing portion 34, the front and rear sidewalls 62, 63 being adjacent to and opposite to the extending arm portion 35b from both of front and rear sides; a flat plate-shaped connecting wall 64 connecting integrally respective projecting ends of the sidewalls 62, 63; and a rib 65 projectingly provided to the door handle case 18 between the pair of sidewalls 62, 63 with the extending arm portion 35b interposed between the rib 65 and the connecting wall 64, the rib 65 extending in an up-down direction. An inclined guide surface 66 is formed on an upper end portion of the rib 65, the inclined guide surface 66 being used for smoothly guiding the extending arm portion 35b to a space between the connecting wall 64 and the rib 65 when the extending arm portion 35b moves to the rib 65 from the nut housing portion 34 side at the time of housing the nut 35 into the nut housing portion 34.

The connecting wall 64 abuts against at least the tip end portion of the extending arm portion 35b, or the full longitudinal length of the extending arm portion 35b in this embodiment, from a direction along a screwing direction 67 of the bolt 37 into the screw hole 38 of the nut 35. The rotation preventing portion 61 is formed in such a shape as to abut against at least the tip end portion of the extending arm portion 35b from the direction along the screwing direction 67.

The second embodiment can bring about the same effect as the first embodiment. In addition, the second embodiment can enhance strength with which the door handle case 18 is attached to the door panel 15 in a way that even when force in a direction in which the door handle case 18 comes off the door panel 15 acts on the nut 35, the rotation preventing portion 61 supports at least the tip end portion of the extending arm portion 35b.

Although the foregoing descriptions have been provided for the embodiments of the present invention, the present invention is not limited to the embodiments. Various design changes may be made without departing from the gist of the present invention.

What is claimed is:

1. A part-fastening structure in which
a nut is unrotatably inserted into a nut housing portion which is provided to a resin-made part from a side of the nut housing portion, and
the part is fastened to a base by screwing a bolt, which is inserted through the base, to the nut, wherein
the nut is formed to integrally include:
a nut main portion having a screw hole in a center portion thereof, and unrotatably inserted into the nut housing portion, and
an extending arm portion extending laterally from an outer periphery of the nut main portion,
a through-hole for penetration of the extending arm portion therethrough is provided to a sidewall opposite to an insertion opening of the nut housing portion, the insertion opening being used for insertion of the nut main portion therethrough, and
the part is integrally provided with a rotation preventing portion for preventing rotation of the nut by abutting against at least a tip end portion of the extending arm portion.

2. The part-fastening structure according to claim 1, wherein the nut is formed symmetrically with respect to a plane passing a center in a width direction of the extending arm portion and a center of the screw hole.

3. The part-fastening structure according to claim 1, wherein the nut housing portion is provided with a pair of guide ribs which project from the part so as to guide the extending arm portion from opposite sides in a width direction of the extending arm portion when inserting the nut into the nut housing portion from the insertion opening.

4. The part-fastening structure according to claim 1, wherein the rotation preventing portion is formed in such a shape as to abut against at least the tip end portion of the extending arm portion from a direction along a screwing direction of the bolt into the screw hole.

5. The part-fastening structure according to claim 2, wherein the nut housing portion is provided with a pair of guide ribs which project from the part so as to guide the extending arm portion from opposite sides in a width direction of the extending arm portion when inserting the nut into the nut housing portion from the insertion opening.

6. The part-fastening structure according to claim 2, wherein the rotation preventing portion is formed in such a shape as to abut against at least the tip end portion of the extending arm portion from a direction along a screwing direction of the bolt into the screw hole.

7. The part-fastening structure according to claim 3, wherein the rotation preventing portion is formed in such a shape as to abut against at least the tip end portion of the extending arm portion from a direction along a screwing direction of the bolt into the screw hole.

8. The part-fastening structure according to claim 5, wherein the rotation preventing portion is formed in such a shape as to abut against at least the tip end portion of the extending arm portion from a direction along a screwing direction of the bolt into the screw hole.
